(19) United States
(12) Patent Application Publication
(10) Pub. No.: US 2012/0321923 A1
(43) Pub. Date: Dec. 20, 2012

(54) SECONDARY BATTERY

(75) Inventor: Young-Kwang YUN, Yongin-si (KR)

(73) Assignee: SAMSUNG SDI CO., LTD., Yongin-si (KR)

(21) Appl. No.: 13/461,023

(22) Filed: May 1, 2012

(30) Foreign Application Priority Data
Jun. 17, 2011 (KR) 10-2011-0059138

(51) Int. Cl. H01M 10/04; H01M 2/30; H01M 2/18; H01M 2/02; H01M 2/08

(52) U.S. Cl. 429/94; 429/163; 429/185; 429/178

(57) ABSTRACT

A secondary battery including: an electrode assembly including first and second electrode plates and a separator interposed between the electrode plates; and a battery case housing the electrode assembly, in which an end portion of the separator which is disposed at the outermost portion of the electrode assembly is housed toward a gas discharging direction.

### CLAIM OF PRIORITY

This application makes reference to, incorporates the same herein, and claims all benefits accruing under 35 U.S.C. §119 from an application earlier filed in the Korean Intellectual Property Office on 17 Jun. 2011 and there duly assigned Serial No. 10-2011-0059138.

### BACKGROUND OF THE INVENTION

1. Field of the Invention

The present invention generally relates to an electrode assembly and a secondary battery.

2. Description of the Related Art

In general, secondary batteries are repeatably chargeable and dischargeable can be easily adopted as power supplies for portable apparatuses and demand has increased with the development electrical, electronic, communication, computer industries, and the like. The secondary batteries have been researched in various fields in order to improve performance and safety as their use patterns and use quantities increase. Further, the demand for miniaturization and high capacity of the rechargeable batteries has been increased. The sizes of the rechargeable batteries are generally increased in order to increase the capacities of the rechargeable batteries, however, on the contrary, various research is in progress with miniaturization of these batteries.

Shapes of the secondary battery may be variously changed and may include a pouch shape of secondary battery, a square shape of secondary battery, a cylindrical secondary battery, or the like. Safety is a significant problem among the performances of the secondary battery and the safety causes further large problem due to a synergy effect by an electronic device used as a power supply of the secondary battery.

The above information disclosed in this Related Art section is only for enhancement of understanding of the background of the invention and therefore it may contain information that does not form the prior art that is already known to a person of ordinary skill in the art.

### SUMMARY OF THE INVENTION

Aspects of the present invention provide for a secondary battery having imporved safety by using a novel manufacturing method of the secondary battery.

Further, another aspect of the present invention is the improvement of production efficiency by preventing the defect generated at the time of manufacturing of the secondary battery.

An exemplary embodiment of the present invention provides a secondary battery including: an electrode assembly including first and second electrode plates and a separator interposed between the electrode plates; and a battery case housing the electrode assembly, in which an end portion of the separator which is disposed at the outermost portion of the electrode assembly is housed toward a gas discharging direction.

The battery case may include a pouch and the pouch may at least partially include a gas collecting part provided to collect the discharged gas.

In addition, the end portion of the separator may be provided toward the gas collecting part.

In this case, the pouch may include a main receiving part including the electrode assembly and a sealing part sealing the main receiving part.

The sealing part may include a first sealing part sealing the main receiving part and a second sealing part to further seal between the main receiving part and the gas collecting part.

Further, the end portion of the separator may be provided toward the second sealing part.

The pouch may include the sealing part and thereafter, may be provided by removing at least a part of the gas collecting part.

The first and second electrode plates each may include first and second electrode tabs and the first and second electrode tabs may protrude to the outside of the battery case.

The battery case may further include a gas collecting part parallel to the first or the second electrode tab.

The first and second electrode tabs each may include a positive electrode tab and a negative electrode tab and the positive electrode tab may be disposed between the negative electrode tab and the gas collecting part.

The electrode assembly may include first and second electrode plates and a separator interposed between the first and second electrode plates and the electrode assembly may be wound so that the separator is disposed at the outermost portion of the electrode assembly.

The electrode assembly may include a plurality of first and second electrode plates which are alternately stacked and the separator may be wound so as to be interposed between the first and second electrode plates.

Further, the separator may be interposed between the first and the second electrode plates in a zigzag shape.

According to aspects of the present invention, the safety of a secondary battery can be improved by a novel manufacturing method.

Further, a manufacture defect can be prevented, such that production efficiency of the secondary battery can be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a secondary battery according to an exemplary embodiment of the present invention.

FIG. 2 is an exploded perspective view of FIG. 1.

FIG. 3A is a perspective view of an electrode assembly according to an exemplary embodiment of the present invention.

FIG. 3B is an exploded perspective view of a battery case according to an exemplary embodiment of the present invention.

FIG. 4A is a perspective view of a pouch including a gas collecting part.

FIG. 4B is a cross sectional view taken along line X-X of FIG. 4A.

FIG. 5 is a cross sectional view of a secondary battery according to another exemplary embodiment of the present invention.

FIG. 6A is an exploded view of an electrode assembly according to another exemplary embodiment of the present invention.

FIG. 6B is an exploded perspective view of a secondary battery according to another exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Details of other exemplary embodiments are included in the detailed description and the accompanying drawings.

Advantages and characteristics of the present invention, and methods for achieving them will be apparent with reference to embodiments described below in detail in addition to the accompanying drawings. However, the present invention is not limited to the exemplary embodiments to be described below, but may be modified in various different ways. Also, when an element is referred to as being “connected to” another element, it can be directly connected to the element or be indirectly connected to the element with one or more intervening elements interposed therebetween. Further, elements not related with the exemplary embodiments of the present invention are not shown in the drawings for clear description of the exemplary embodiments of the present invention. Throughout the specification, like reference numerals refer to like elements.

Hereinafter, the present invention will be described with reference to the accompanying drawings.

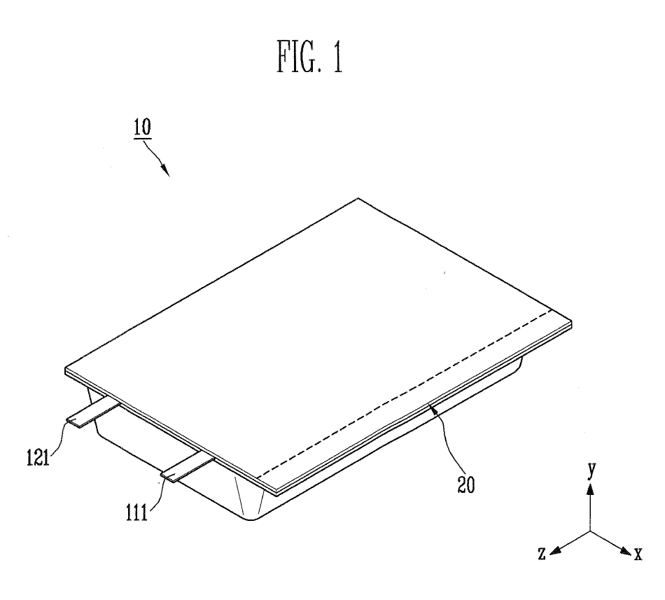

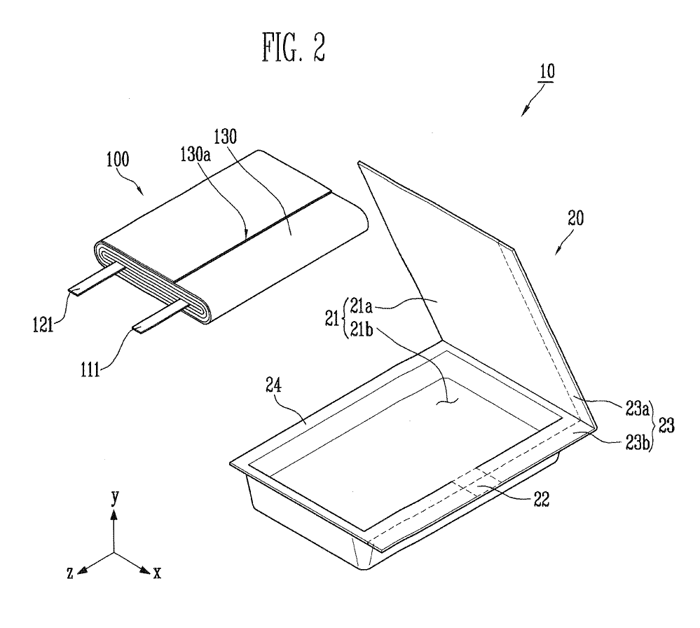

FIG. 1 is a perspective view of a secondary battery according to an exemplary embodiment of the present invention and FIG. 2 is an exploded perspective view of FIG. 1.

Referring to FIGS. 1 and 2, a secondary battery 10 according to the exemplary embodiment of the present invention includes an electrode assembly 100 including first and second electrode plates 110 and 120 and a separator 130 interposed between the electrode plates; and a battery case 20 housing the electrode assembly 100, in which an end portion 130a of the separator 130 which is disposed at the outermost portion of the electrode assembly 100 is housed toward a gas discharging direction.

For example, when the gas discharging direction heads toward an. X-direction, the electrode assembly 100 may be housed in the battery case 20 so that a positive electrode tab 111 or a negative electrode tab 121 heads toward a Z-direction. In addition, the end portion 130a of the separator 130 may be provided to head toward an X-direction.

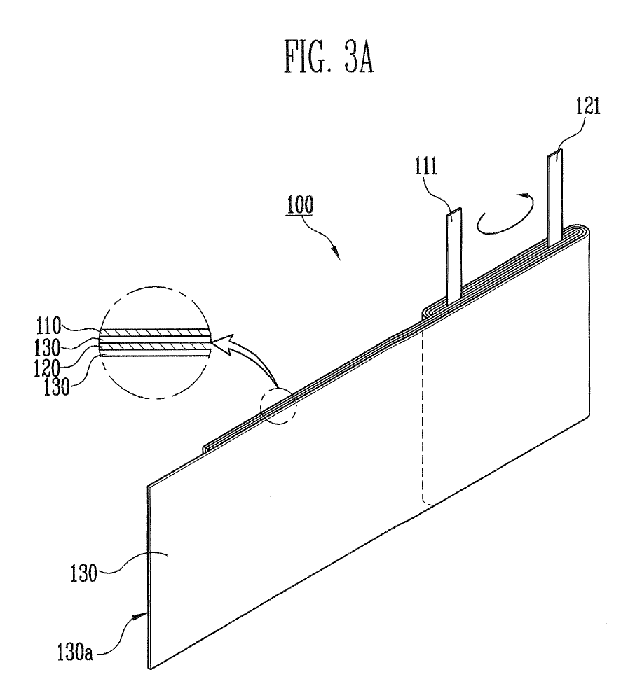

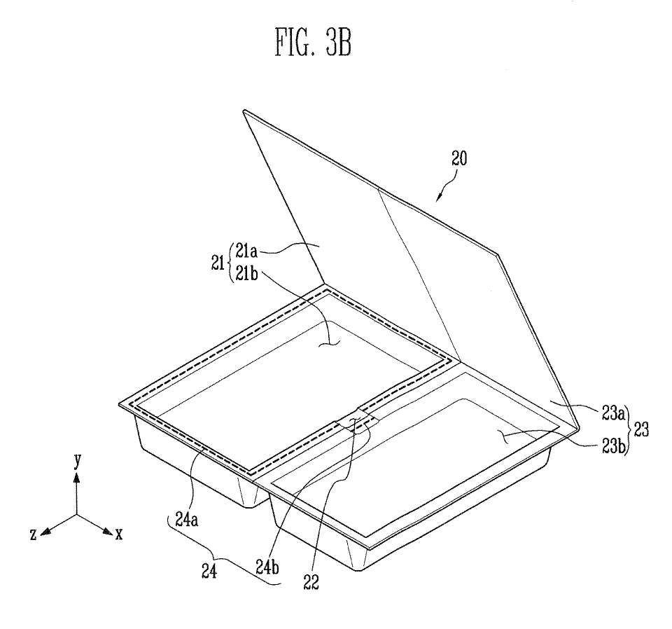

FIG. 3A is a perspective view of an electrode assembly according to an exemplary embodiment of the present invention and FIG. 3B is an exploded perspective view of a battery case according to an exemplary embodiment of the present invention.

Referring to FIGS. 2 and 3A, the electrode assembly 100 may include first and second electrode plates 110 and 120 and a separator 130 interposed between the electrode plates.

The first electrode plate 110 may be a positive electrode plate. The positive electrode plate 110 may include a coated portion with the positive active material on the substrate and a non-coated portion without the positive active material. In addition, the second electrode plate 120 may be a negative electrode plate. The negative electrode plate 120 may include a coated portion with the negative active material on the substrate and a non-coated portion without the negative active material. The separator 130 may be interposed between the positive electrode plate 110 and the negative electrode plate 120. The separator 130 is an ion passage and prevents the positive electrode plate 110 and the negative electrode plate 120 from coming in direct contact with each other.

The electrode assembly 100 may include the positive electrode plate 110, the negative electrode plate 120, and the separator 130 interposed between the electrode plates. In the electrode assembly 100, the positive electrode plate 110 and the negative electrode plate 120 may face each other so that the current efficiently moves. In this case, the separator 130 may be interposed between the electrode plates and wound so as to be provided at the outermost portion of the electrode assembly 100. In addition, the separator 130 may be provided so as to have a length longer than the electrode plates in order to prevent a short between the electrode plates. The electrode assembly 100 may include the end portion 130a of the separator 130 at the outermost portion thereof.

Further, the electrode assembly 100 may further include a positive electrode tab 111 and a negative electrode tab 121. The positive electrode tab 111 may be provided in the positive electrode plate 110 and the negative electrode tab 121 may be provided in the negative electrode plate 120. The positive electrode tab 111 and the negative electrode tab 121 may be provided so as to protrude to the outside from the electrode assembly 100 and act as a passage transferring electrochemical energy generated by the electrode plates to the outside.

Referring to FIGS. 2 and 3B, the battery case 20 may house the electrode assembly 100 and an electrolyte therein.

The battery case 20 may include a pouch. The batterycase/pouch 20 includes a main receiving part 21 housing the electrode assembly 100 and the electrolyte and may at least partially include a gas collecting part 23 provided to collect the discharged gas.

The energy in the secondary battery 10 is generated by reacting with the electrode assembly 100 and the electrolyte and a gas may be generated by a side reaction according to the reaction. A lot of gas may be generated by a charge and the like in an aging process of the secondary battery. In particular, the gas causes problems such as the deformation of the electrode assembly 100 stored therein and the accompanying exterior defect.

Accordingly, in the secondary battery according to the exemplary embodiment of the present invention, a process removing the inner gas may be performed. The secondary battery may include a gas passage 22 provided between the main receiving part 21 and the gas collecting part 23 so as to communicate the main receiving part 21 and the gas collecting part 23. The gas generated in the main receiving part 21 may move to the gas collecting part 23 through the gas passage 22 by a vacuum.

Further, the pouch 20 may further include a sealing part 24. The sealing part 24 is a part provided so as to prevent a material stored in the pouch 20 from being left and for example, is provided so as to seal the main receiving part 21 of the pouch 20. The sealing part 24 may include first and second sealing parts 24a and 24b. The first sealing part 24a may be provided at the periphery of the main receiving part 21 so as to seal the main receiving part 21. In addition, the second sealing part 24b may be provided between the main receiving part 21 and the gas collecting part 23 and may be further provided after the first sealing part 24a is provided. Further, the end portion 130a of the separator 130 may be provided toward the second sealing part 24b.

First, the first sealing part 24a may be provided except in the area of the gas passage 22 provided between the main receiving part 21 and the gas collecting part 23. The pouch 20 including the first sealing part 24a may move the gas in the main receiving part 21 to the gas collecting part 23 through the gas passage 22 by a vacuum. As described above, after the gas is removed from the main receiving part 21, the second sealing part 24b is provided so as to seal the gas passage 22.

In the secondary battery 10 according to the exemplary embodiment, the gas may be removed from the main receiving part 21 by a vacuum and the vacuum removes the gas and may influence even the electrode assembly 100 provided in the main receiving part 21.

The electrode assembly 100 may be provided so as to surround the outermost portion thereof with the separator 130 in order to prevent the electric connection with the pouch 20. In this case, the vacuum may cause a fold or a crease of the separator 30 disposed at the outermost portion, such that an exterior defect or a performance deterioration of the secondary battery may occur. In addition, in extreme cases, the separator 130 may prevent the sealing part 24 of the pouch 20 from being sealed, such that a leakage of the electrolyte may be generated. When the electrode assembly 100 according to the exemplary embodiment is housed in the pouch 20, the electrode assembly 100 may be housed so that the end portion 130a of the separator 130 heads toward the gas discharging direction.

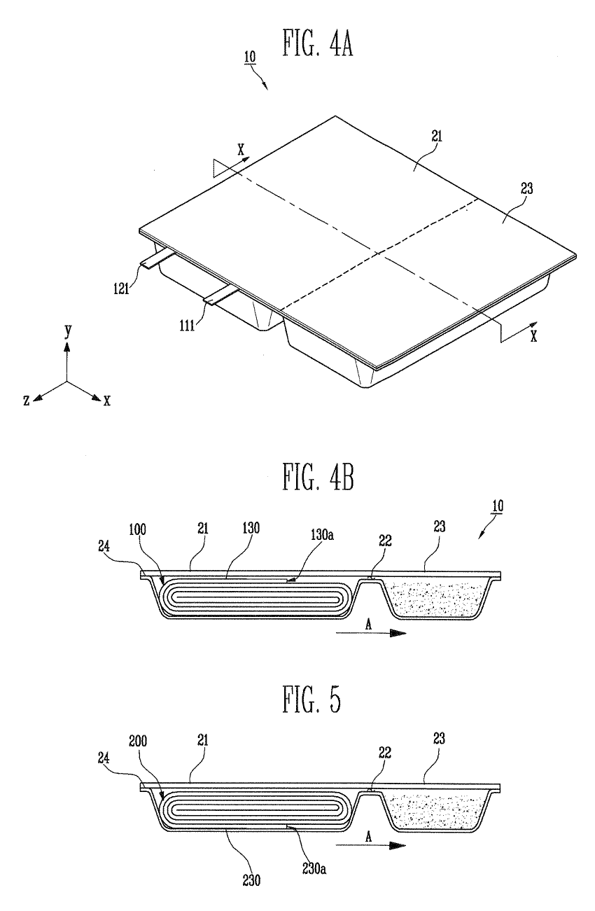

FIG. 4A is a perspective view of a pouch including a gas collecting part and FIG. 4B is a cross sectional view taken along line X-X of FIG. 4A.

Referring to FIGS. 4A and 4B, the gas collecting part 23 is disposed in at least one side of the pouch 20 and the end portion 130a of the separator 130 is disposed toward the gas collecting part 23. In addition, the positive electrode plate 110 and the negative electrode plate 120 configuring the electrode assembly 100 includes a positive electrode tab 111 and a negative electrode tab 121 and the positive electrode tab 111 and the negative electrode tab 121 may protrude to the outside of the pouch 20.

The pouch 20 may further include a gas collecting part 23 parallel to the positive electrode tab 111 and the negative electrode tab 121. In this case, the positive electrode tab 111 may be disposed between the negative electrode tab 121 and the gas collecting part 23. That is, the electrode assembly 100 may be provided so that the positive electrode tab 111 is adjacent to the gas collecting part 23.

The secondary battery 10 according to the exemplary embodiment may be charged and discharged by a charger and discharger. In this case, the charger and discharger may include a positive charge terminal and a negative charge terminal corresponding to each of the positive electrode tab 111 and the negative electrode tab 121 of the secondary battery 10. In this case, a space housing at least a part of the gas collecting part 23 of the secondary battery 10 may be provided at a side of the positive charge terminal of the charger and discharger. The gas collecting part 23 may be easily seated in the space housing gas collecting part 23 included in the charger and discharger, such that the secondary battery 10 is fixed to the charger and discharger, thereby easily charging and discharging.

In addition, the end portion 130a of the separator 130 of the electrode assembly 100 may be provided toward the gas collecting part 23. In the secondary battery 10, the gas generated therein may be removed by a vacuum and the gas may head toward an A-direction. The end portion 130a of the separator 130 is provided toward a removed direction A of the gas, such that the end portion 130a does not have a problem such as a crease and the like due to the vacuum.

Further, the pouch 20 may include a first and second sealing part 24 and thereafter, may be provided by removing at least a part of the gas collecting part 23. The gas generated therein is removed and thereafter, the gas collecting part 23 does not have an influence on a function of the charge or discharge of the secondary battery 10. Accordingly, the gas collecting part 23 may be removed, such that the secondary battery 10 can be compact.

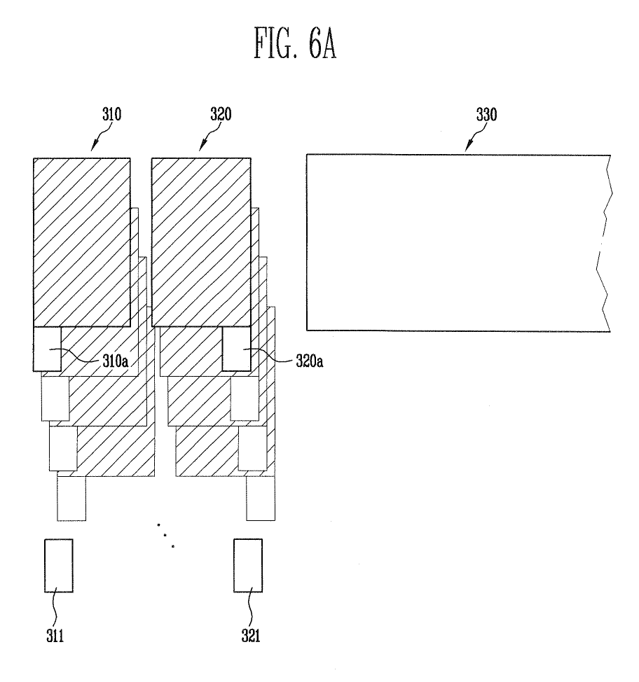

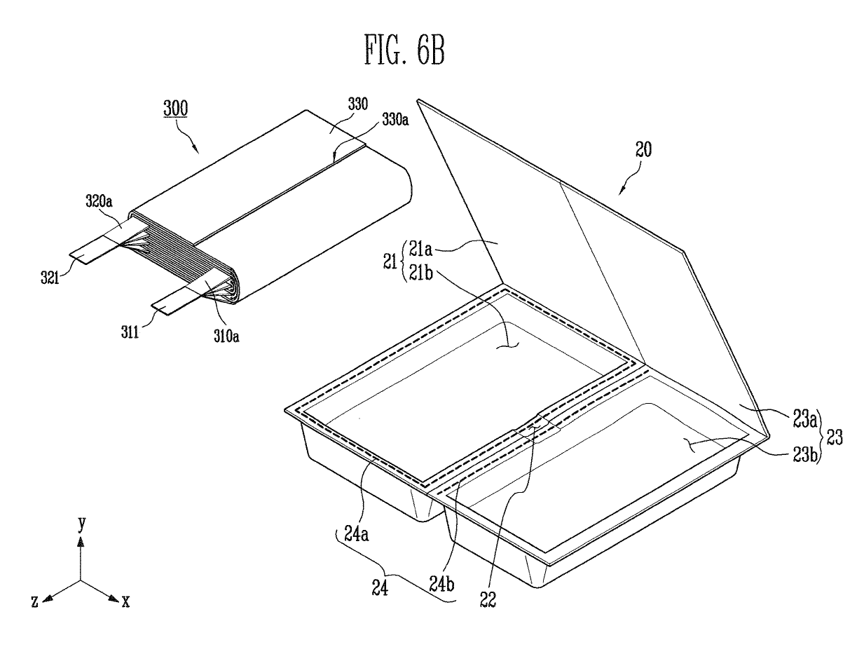

Hereinafter, another exemplary embodiment of the present invention will be described with reference to FIGS. 5 and 6B. Except for contents to be described below, since another exemplary embodiment of the present invention is similar to the exemplary embodiment described in FIGS. 1 to 4B, the detailed description is omitted.

FIG. 5 is a cross sectional view of a secondary battery according to another exemplary embodiment of the present invention.

Referring to FIG. 5, the secondary battery according to the exemplary embodiment includes an electrode assembly 200 including a positive electrode plate, a negative electrode plate, and a separator 230 interposed between the electrode plates; and a pouch 20 housing the electrode assembly 200, in which the electrode assembly 200 is housed in the pouch 20 so that an end portion 230a of the separator 230 provided so as to surround the outermost portion of the electrode assembly 200 heads toward a gas discharging direction A.

In the electrode assembly 200, a winding type of the separator 230 may be vary according to a design of the secondary battery 10. Similar to previous exemplary embodiments discussed, when the separator 230 is disposed in a main receiving part 21 of the pouch 20, the end portion 230a of the separator 230 may contact a body or portion of the pouch 20. In the electrode assembly 200, the end portion 230a may be provided toward the gas passage 22 through which the gas is discharged, that is, the gas collecting part 23. Accordingly, although an inner pressure is applied by the vacuum and the like, the deformation of the separator 230 can be prevented, such that production efficiency of the secondary battery can be improved.

FIG. 6A is an exploded view of an electrode assembly according to another exemplary embodiment of the present invention and FIG. 6B is an exploded perspective view of a secondary battery according to another exemplary embodiment of the present invention.

Referring to FIGS. 6A and 6B, the secondary battery according to the exemplary embodiment includes an electrode assembly 300 and a pouch 20 housing the electrode assembly 300 and in the electrode assembly 300, an end portion 330a of a separator 330 may be provided toward a gas collecting part 23.

The electrode assembly 300 includes a plurality of positive electrode plates 310 and negative electrode plates 320 which are alternately stacked to each other and the separator 330 may be wound so as to be interposed between the electrode plates.

The electrode assembly 300 may be manufactured by alternately stacking the positive electrode plates 310 and negative electrode plates 320 configured by a plurality of units and winding the separator 330 provided between the stacked electrode plates in a sheet shape. In addition, the separator 330 may be interposed between the positive electrode plates 310 and negative electrode plates 320 in a zigzag shape. In this case, the positive electrode plates 310 and negative electrode plates 320 may include a positive electrode tab part 310a and a negative electrode tab part 320a. The positive and negative electrode tab parts 310a and 320a are portions where the active material is not included in the substrate and may protrude therefrom. Further, the positive and negative electrode tab parts 310a and 320a may facilitate the stacking of the electrode plates and may be provided in order to be electrically connected between the stacked electrode plates having the same polarity. The positive and negative electrode tab parts 310a and 320a are collected at one place by welding and the tab parts collected at one place may be welded with a separate positive electrode tab 311 and a negative electrode tab 321. The positive electrode tab 311 and the negative electrode tab 321 may be provided so as to protrude outside the pouch 20 and may be electrically connected with an external electronic device.

Further, the electrode assembly 300 may be disposed in the pouch 20 so that the end portion 330a of the separator 330 head toward the removed direction of the gas. The pouch 20 including the electrode assembly 300 and the electrolyte may be charged by a charging device and the gas generated in the charge may be removed to the gas collecting part 23 by the vacuum. The electrode assembly 300 may be provided so that the end portion 330a of the separator 330 which is disposed at the outermost portion of the electrode assembly 300 heads toward the removed direction of the gas. Accordingly, in the removing process of the gas generated therein, the deformation of the separator can be prevented and defects such as, leakage of the electrolyte can be prevented.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

What is claimed is:

1. A secondary battery, comprising:
an electrode assembly including first and second electrode plates and a separator interposed between the first and second electrode plates; and
a battery case housing the electrode assembly,
wherein an end portion of the separator which is disposed at an outermost portion of the electrode assembly, said end portion is positioned toward a gas discharging direction of the battery case.

2. The secondary battery according to claim 1, wherein the battery case includes a pouch and the pouch at least partially includes a gas collecting part that collects discharged gas.

3. The secondary battery according to claim 2, wherein the end portion of the separator is postioned toward and in a direction of the gas collecting part.

4. The secondary battery according to claim 2, wherein the pouch includes a main receiving part including the electrode assembly and a sealing part sealing the main receiving part.

5. The secondary battery according to claim 4, wherein the sealing part includes a first sealing part sealing the main receiving part and a second sealing part further seal an area between the main receiving part and the gas collecting part.

6. The secondary battery according to claim 5, wherein the end portion of the separator is positioned toward and in the direction of the second sealing part.

7. The secondary battery according to claim 4, wherein the pouch includes the sealing part and thereafter, is provided by removing at least a part of the gas collecting part.

8. The secondary battery according to claim 1, wherein the first and second electrode plates each includes first and second electrode tabs, said first and second electrode tabs protrude outside of the battery case.

9. The secondary battery according to claim 8, wherein the battery case further includes a gas collecting part parallel to the first or the second electrode tab.

10. The secondary battery according to claim 9, wherein the first and second electrode tabs each includes a positive electrode tab and a negative electrode tab and the positive electrode tab is disposed between the negative electrode tab and the gas collecting part.

11. The secondary battery according to claim 1, wherein the electrode assembly includes first and second electrode plates and a separator interposed between the first and second electrode plates and the first and second electrode plates and the separator are wound.

12. The secondary battery according to claim 1, wherein the electrode assembly includes a plurality of first and second electrode plates which are alternately stacked and the separator is wound so as to be interposed between the first and second electrode plates.

13. The secondary battery according to claim 12, wherein the separator is interposed between the first and the second electrode plates in a zigzag shape.

14. A secondary battery, comprising:
a battery case having a first chamber connected to a gas passage, said gas passage is positioned on a portion of one side the battery case; and
an electrode assembly housed in first chamber of the battery case, comprising:
a first electrode plate;
a second electrode plate;
a first separator interposed between the first and second electrode plate; and
a second separator disposed on the second electrode plate,
wherein said first electrode plate, said second electrode plate, said first separator and said second seaparator are wound to position the second separator on an exterior surface of the electrode assembly with said first electrode plate, said second electrode plate, said first separator and said second separator terminating with an end portion on the exterior surface of the electrode assembly, and
wherein said end portion of the electrode assembly faces the gas passage of the battery case.

15. The secondary battery recited in claim 14, wherein the battery case further comprises: a second chamber having at least a partial vacumm, said second chamber is connected to the gas passage forming a gas collecting part that collects discharged gas from the first chamber created during the charging and discharging of the secondary battery.

16. The secondary battery recited in claim 14, wherein said second separator is longer than said first electrode plate, said second electrode plate, said first separator and extends beyond said end portion of the electrode assembly.

17. The secondary battery recited in claim 16, wherein said second separator faces the gas passage of the battery case.

18. The secondary battery recited in claim 14, wherein the battery case is sealed to form an airtight structure.

19. The secondary battery recited in claim 15, wherein the first chamber is sealed with a first sealing part that excludes the gas passage.

20. The secondary battery recited in claim 19, wherein the gas passage is sealed with a second sealing part and the second chamber is detached from the first chamber.
